(19) United States
(12) Patent Application Publication
(10) Pub. No.: US 2022/0206771 A1
(43) Pub. Date: Jun. 30, 2022

(54) TEMPLATE BASED APPROACH AUTOMATING THE LIFECYCLE OF API MANAGEMENT DEPLOYMENT

(71) Applicant: Karthikeyan Subramanian, Voorhees, NJ (US)

(72) Inventor: Karthikeyan Subramanian, Voorhees, NJ (US)

(21) Appl. No.: 17/133,689

(22) Filed: Dec. 24, 2020

(51) Int. Cl. G06F 8/60; G06F 9/54; G06F 8/10; G06F 8/35

(52) U.S. Cl. CPC G06F 8/60; G06F 8/35; G06F 8/10; G06F 9/541

(57) ABSTRACT

The present invention is directed towards a method 200 and system 100 to automate the entire lifecycle of Apigee API Management deployment via a templated approach, the method 200 comprising steps of receiving data related to application programming interfaces from the customer device 102a at the developer device 102b, validating the data for knowing the state of existing application programming interfaces (APIs), creating a template based on customer requirement, wherein the template is creating by generating an APIGEE® application programming interface proxy 412 and customer integration or customer delivery (CI/CD) configuration 414 based on the data, storing the APIGEE® application programming interface proxy and customer integration or customer delivery configuration at a data repository, generating a repeatable build job for deployment of the APIGEE R application programming interface proxy and customer integration or customer delivery configuration and deploying and executing the job on the on premises or cloud server.

### FIELD OF THE INVENTION

The present invention generally relates to the Application programming interference (API) management and more to a templated approach to automate the entire lifecycle of API Management deployment.

### BACKGROUND OF THE INVENTION

Application Programming Interfaces (APIs) are typically employed to provide communication between applications and underlying data in a system or services provided by an organisation or agency. The API management services can regulate APIs that use data/services from the backend and control the use of data/services from the backend. Traditionally the APIs are managed by manual coding which is a time taking process and it is also costly to deploy an API management service.

Therefore, there is a need in art for a method and system to automate the entire lifecycle of API Management deployment.

### SUMMARY OF THE INVENTION

It is therefore an object of this invention to provide a templated approach to automate the entire lifecycle of API Management deployment.

According to one aspect of the present invention, there is provided a system 100 to automate the entire lifecycle of APIGEE® (a registered trademark of Apigee Corporation of Palo Alto, Calif.) API Management deployment via a templated approach, the system 100 comprises a customer device 102a associated with a customer 404, a developer device 102b associated with a developer 408, a processing module 106 include a memory unit 1062 storing machine readable instructions and a processor 1064 operably coupled with the memory unit 1062, the machine readable instructions, when executed by the processor 1064, configure the system 100 to perform one or more operations comprises, receive data related to application programming interfaces from the customer device 102a at the developer device 102b, validate the data for knowing the state of existing application programming interfaces (APIs), create a template based on customer requirement, wherein the processor 1064 is configured to create the template by generating an APIGEE® application programming interface proxy 412 and customer integration or customer delivery (CI/CD) configuration 414 based on the data, storing the APIGEE® application programming interface proxy and customer integration or customer delivery configuration at a data repository 108, generating a repeatable build job for deployment of the APIGEE application programming interface proxy and customer integration or customer delivery configuration and deploying and executing the job on the on premises or cloud server.

In accordance with an embodiment of the present invention, the customer device 102a and developer device 102b are selected from, but not limited to computer systems, tablet devices, mobile telephone devices, server computer systems, handheld or laptop devices, multiprocessor systems, microprocessor-based systems, set top boxes, programmable consumer electronics, network PCs, and a distributed cloud computing environments.

In accordance with an embodiment of the present invention, the data is selected from, but not limited to open application programming interfaces specification, metadata configuration, and shared flows.

In accordance with an embodiment of the present invention, the template is an abstraction of a design pattern.

In accordance with an embodiment of the present invention, the APIGEE® application programming interface proxy 414 is a user interface for a developer to use backend services.

In accordance with an embodiment of the present invention, the customer integration or customer delivery configuration 414 utilizes pull request-based code review workflows to automate deployment of code changes to a live software system.

In accordance with an embodiment of the present invention, the repeatable build jobs are performed by the tool is selected from Jenkins, Bamboo, and Azure AD.

According to second aspect of the present invention, there is a method 200 provided to automate the entire lifecycle of Apigee API Management deployment via a templated approach, the method 200 comprising steps of receiving data related to application programming interfaces from the customer device 102a at the developer device 102b, validating the data for knowing the state of existing application programming interfaces (APIs), creating a template based on customer requirement, wherein the template is creating by generating an APIGEE® application programming interface proxy 412 and customer integration or customer delivery (CI/CD) configuration 414 based on the data, storing the APIGEE® application programming interface proxy and customer integration or customer delivery configuration at a data repository, generating a repeatable build job for deployment of the APIGEE® application programming interface proxy and customer integration or customer delivery configuration and deploying and executing the job on the on premises or cloud server.

In accordance with an embodiment of the present invention, the customer device 102a and developer device 102b are selected from, but not limited to computer systems, tablet devices, mobile telephone devices, server computer systems, handheld or laptop devices, multiprocessor systems, microprocessor-based systems, set top boxes, programmable consumer electronics, network PCs, and a distributed cloud computing environments.

In accordance with an embodiment of the present invention, the data is selected from, but not limited to open application programming interfaces specification, metadata configuration, and shared flows.

In accordance with an embodiment of the present invention, the template is an abstraction of a design pattern.

In accordance with an embodiment of the present invention, the APIGEE® application programming interface proxy 412 is a user interface for a developer to use backend services.

In accordance with an embodiment of the present invention, the customer integration or customer delivery configuration 414 utilizes pull request-based code review workflows to automate deployment of code changes to a live software system.

In accordance with an embodiment of the present invention, the repeatable build jobs are performed by the tool is selected from Jenkins, Bamboo, and Azure AD.

### BRIEF DESCRIPTION OF THE DRAWINGS

The numerous advantages of the present invention may be better understood by those skilled in the art by reference to the accompanying figures in which:

FIG. 1 is an exemplary environment of computing devices to which the various embodiments described herein may be implemented, in accordance with an embodiment of the present invention.

FIG. 2 is a flow chart illustrating a method to automate the entire lifecycle of API Management deployment.

FIG. 3 is a flow chart illustrating a method to create a template.

FIG. 4 illustrate an information flow diagram of the process's involvement in entire lifecycle of API management.

### DETAILED DESCRIPTION OF THE DRAWINGS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labelled with identical element numbers for ease of understanding. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject, matter not recited, and is not intended to exclude other additives, components, integers or steps. Likewise, the term “comprising” is considered synonymous with the terms “including” or “containing” for applicable legal purposes.

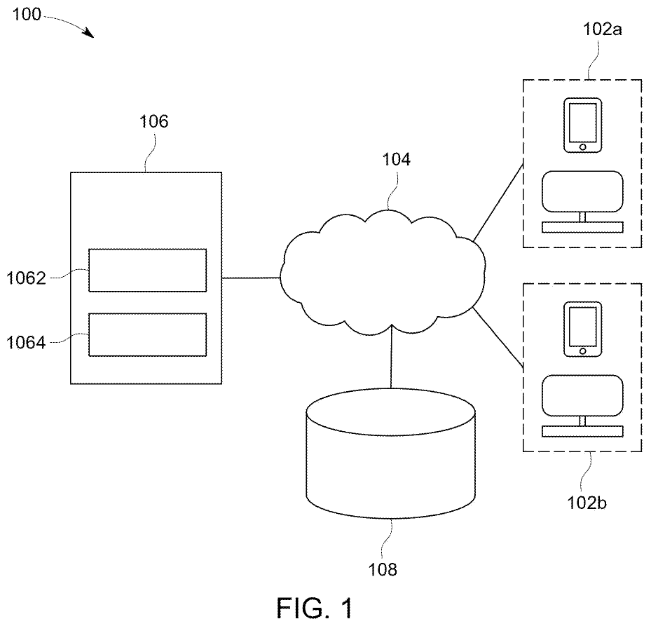

FIG. 1. is an exemplary environment 100 for a templated approach to automate the entire lifecycle of Apigee API Management deployment to which the various embodiments described herein may be implemented. FIG. 1. illustrates a customer device 102a associated with a customer who is looking to manage his application programming interfaces (APIs) and developer device 102b associated with the developer who develop the template for API management. The customer device 102a and developer device 102b may be selected from a group comprising mobile handheld devices (such as mobile phones, PDA and tablet PCs etc.), desktop PCs and notebooks etc. The customer device 102a and developer device 102b is envisaged to be connected with one or more input devices (such as a keyboard, a camera, microphone etc.) (not shown) and one or more output devices (such as a display screen, speaker etc.) (not shown). In case of mobile handheld devices such as a smartphone, the one or more input devices and the one or more output devices may be integrally provided. The customer device 102a and developer device 102b is connected with a network 104. The network 104 may be one of, but not limited to, a Local Area Network (LAN) or a Wide Area Network (WAN). The network 104 may be implemented using a number of protocols, such as but not limited to, TCP/IP, 3GPP, 3GPP2, LTE, IEEE 802.x etc.

Further connected to the network 104 is a processing module 106. The processing modules 106 are selected from but not limited to a processor, a microprocessor, and an operation Processing one or a combination of circuit components. The processing module 106 is envisaged to include computing capabilities such as a memory unit 1062 configured to store machine readable instructions. The machine-readable instructions may be loaded into the memory unit 1062 from a non-transitory machine-readable medium such as, but not limited to, CD-ROMs, DVD-ROMs and Flash Drives. Alternately, the machine-readable instructions may be loaded in a form of a computer software program into the memory unit 1062. The memory unit 1062 in that manner may be selected from a group comprising EPROM, EEPROM and Flash memory.

Further, the processing module 106 includes a processor 1064 operably connected with the memory unit 1062. In various embodiments, the processor 1064 is one of, but not limited to, a general-purpose processor, an application specific integrated circuit (ASIC) and a field-programmable gate array (FPGA).

Further connected to the network 104 is a data repository 108. The data repository 108 may be a cloud-based storage or a local storage. In any manner, the data repository 108 is envisaged to be capable of providing the data to any of the computing devices connected with the network 104, when the data is queried appropriately using applicable security and other data transfer protocols. The data repository 108 is envisaged to store the APIs data. The APIs data are selected from, but not limited to open application programming interfaces specification, metadata configuration, and shared flows. Various embodiments of the present invention may now be understood with the exemplary environment 100 as a reference.

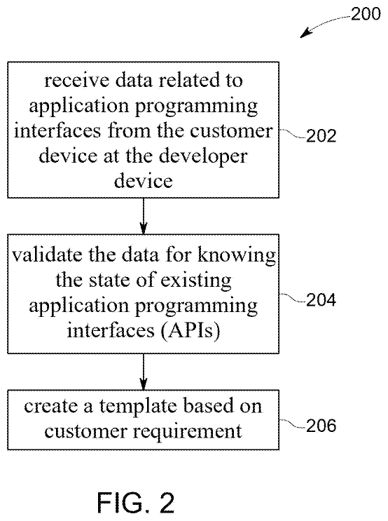

FIG. 2. is a flow chart illustrating a method 200 to automate the entire lifecycle of Apigee API Management deployment via a templated approach, in accordance with an embodiment of the present invention.

The method starts at step 202 where the data related to application programming interfaces is collected from the customer devices 102a at the developer device 102b. Further the data collected are selected from, but not limited to open application programming interfaces specification, metadata configuration, and shared flows.

At step 204, the developer 408 validates the collected data, wherein the validation is conducted to know the state of existing APIs. Further the developer understands the deployment model of the APIs.

At step 206, the developer 408 creates a template to APIs management deployment, wherein the template is designed as per the customer requirement. The template incudes the API functioning map to manage all the APIs automatically.

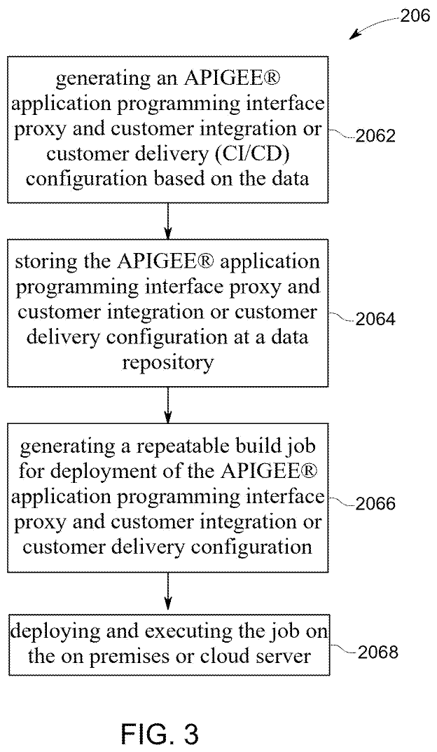

FIG. 3. is a flow chart illustrating a method to create a template 206, in accordance with an embodiment of the present invention.

The method starts at step 2062 where the developer generates the APIGEE® application programming interface proxy 412 and customer integration or customer delivery configuration 414 by using the collected data at the developer device 102b. The APIGEE® application programming interface proxies are a user interface for a developer to use backend services and customer integration or customer delivery configuration utilizes pull request-based code review workflows to automate deployment of the proxies changes to a live software system.

At step 2064, after generating APIGEE® application programming interface proxy and customer integration or customer delivery configuration the developer store them at a data repository 108, wherein the data repository 108 can be a source code repository 416.

At step 2066, the developer creates a job to deploy the APIGEE® application programming interface proxy and customer integration or customer delivery configuration. The job is a repeatable build job, wherein the repeatable build jobs are performed by the tool is selected, but not limited to from Jenkins, Bamboo, and Azure AD.

At step 2068, the developer run the job and deploy the API at the on premises or cloud server for its function and execute it when needed.

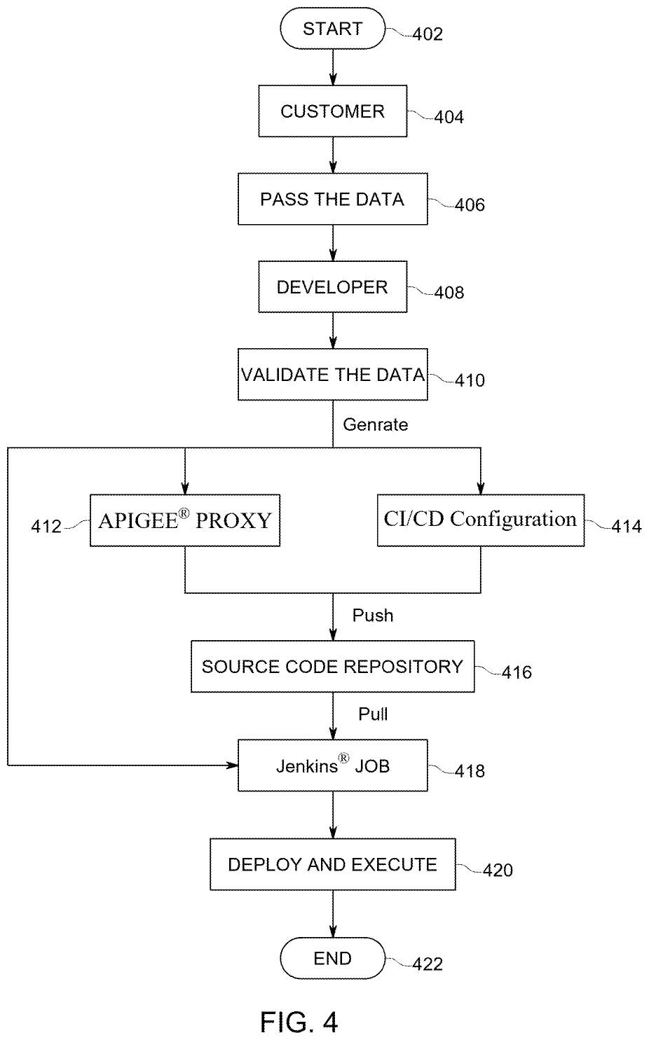

FIG. 4. illustrates an information flow diagram of the process's involvement in entire lifecycle of API management. Process start at 402 thereafter the customer 404 from customer device 102a passes the data 406 related to APIs to the developer 408 at the developer device 102b, wherein the developer 408 may ask a questionnaire to customer in order to collect the data and the customer answers the questionnaire. The questionnaire can be related to any information required to manage and deploy the APIs like open application programming interfaces specification, existing deployment model and metadata configuration etc.

After receiving the data, the developer 408 validates the data 410 for knowing the existing state of the APIs, wherein the validation process is performed at the developer device. The validation is conducted to understand and capture the requirements to customize the solution toolset for each customer scenario.

After understanding the requirement of the customer and state of existing APIs, the developer plan or choose the template type. Further, the developer generates the APIGEE® APIs proxies 412 and CI/CD configuration 414 according to the template. The APIs proxies 412 and CI/CD 414 configuration are stored at the data repository? wherein the data repository can be a source code repository 416.

Once the APIs proxies and CI/CD configuration are stored at the data repository, the developer generates the job to CI/CD deployment, wherein the job may be Jenkines' job 418. In Jenkines' job 418 a source code is created to automate the process. The source code can be merged from any of the source code management like git, SVN, and perforce. The job is a repeatable built job for deployment APIGEE® APIs. while building the job the APIGEE® APIs proxies and CI/CD configuration are pulled from the data repository. Further the APIGEE® APIs proxies are deployed with the CI/CD configuration to create the job.

After the job has been created, the developer deploys the job and executes it as per the customer's requirements and provides the customer with an Onprem Install (Onprem customer) (OR) a custom SaaS hosted URL which will host the custom

The customer has 2 options to use the template.

a. A CLI (Command line interface): To invoke the tool the user needs to have the following information available.
i. Custom URL for invoking the tool (provided post provisioning and contracts)
ii. An OAS(Open API Specification)
iii. Metadata-Config.yaml—Defines entities like proxy name, template type, base path, (see below configuration example)

```
---
# Choose the base template for generating proxy
templateSource: apikeyauthv1.0
# Metadata for API Proxy used to update the default.xml
and create the <proxyName>.xml in the proxy bundle.
metadata:
proxyName: Apex-trading-v1
orgName: {Apigee Org Name}
description: Demo Proxy for mock
basePath: /apex-trading/v1
virtualHosts:
  - secure
targetEndpoints:
  - default
# Target endpoint for a given proxy. Target endpoints
are responsible for making the backend calls.
# Target endpoints also has references to Target servers
being utilized, how they are load balanced, etc.
targetEndpoints:
  - name: default
  description: Default target endpoint pointing to mock server
  routeRule: request.verb != ″OPTIONS″
  loadBalancerConfig:
    targetServers:
    - name: apextrading
    path: /
# Headers to be sent from APIGEE ® to backend
headersForBackend:
- name: {Headed Name}
  value: {Headed Value}
- name: {Header2 Name}
  value: {Header2 Value}
gitInfo:
  repoUrlfittps: {Git Repo Http URL}
  repoUrlSSH: {Git Repo SSH URL}
  ## If it is not provided, default will be ″automation″
  branch: master
cicdInfo:
  configRepoUr1Https: {CI/CD Git Repo Http URL}
  ClServiceAccount: {Service Account}
```

b. GUI (Graphical User Interface)

The GUI will take an Open API Specification and build the metadata and then invoke the server URL.

Output: Both forms of input (GUI&CLI) would create Apigee Proxies, Shared Flows, CI configuration, create Code and config repos and then invoke the CI job. The CI Job would pull the configuration from the Software configuration management (SCM) repository, build the proxy, deploy the proxy, run any integration tests, run any penetration tests and provide a custom message about the status of the deployment.er solution installation in the cloud.

Those skilled in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. For example, while the foregoing was described in the context of a rewards or redemption program and associated liabilities, it will be understood that other applications may use aspects of the subject technology to track information and assess changing value as provided by the system and method disclosed. Thus, the claims are not intended to be limited to the aspects shown herein but is to be accorded the full scope consistent with the language claims.

What is claimed is:

1. A system 100 to automate the entire lifecycle of APIGEE® API Management deployment via a templated approach, the system 100 comprising:
a customer device 102a associated with a customer 404;
a developer device 102b associated with a developer 408;
a processing module 106 including:
a memory unit 1062 storing machine readable instructions; and
a processor 1064 operably coupled with the memory unit 1062, the machine readable instructions, when executed by the processor 1064, configure the system 100 to perform one or more operations comprising:
receive data related to application programming interfaces from the customer device 102a at the developer device 102b;
validate the data for knowing the state of existing application programming interfaces (APIs);
create a template based on customer requirement;
wherein the processor 1064 is configured to create the template by:
generating an APIGEE® application programming interface proxy 412 and customer integration or customer delivery (CI/CD) configuration 414 based on the data;
storing the APIGEE® application programming interface proxy 412 and customer integration or customer delivery configuration 414 at a data repository;
generating a repeatable build job for deployment of the APIGEE® application programming interface proxy 412 and customer integration or customer delivery configuration 414; and
deploying and executing the job on the on premises or cloud server.

2. The system as claimed in claim 1, wherein the customer device 102a and developer device 102b is selected from computer systems, tablet devices, mobile telephone devices, server computer systems, handheld or laptop devices, multiprocessor systems, microprocessor-based systems, set top boxes, programmable consumer electronics, network PCs, and a distributed cloud computing environments.

3. The system as claimed in claim 1, wherein the data is selected from open application programming interfaces specification, metadata configuration, and shared flows.

4. The system as claimed in claim 1, wherein the template is an abstraction of a design pattern.

5. The system as claimed in claim 1, wherein the APIGEE® application programming interface proxy 412 is a user interface for a developer to use backend services.

6. The system as claimed in claim 1, wherein the customer integration or customer delivery configuration 414 utilizes pull request-based code review workflows to automate deployment of code changes to a live software system.

7. The system as claimed in claim 1, wherein the repeatable build jobs are performed by the tool is selected from Jenkins, Bamboo, and Azure AD.

8. A method 200 to automate the entire lifecycle of Apigee API Management deployment via a templated approach, the method 200 comprising steps of:
receiving data related to application programming interfaces from the customer device 102a at the developer device 102b;
validating the data for knowing the state of existing application programming interfaces (APIs);
creating a template based on customer requirement;
wherein the template is creating by:
generating an APIGEE® application programming interface proxy 412 and customer integration or customer delivery (CI/CD) configuration 414 based on the data;
storing the APIGEE® application programming interface proxy 412 and customer integration or customer delivery 414 configuration at a data repository 108;
generating a repeatable build job for deployment of the APIGEE® application programming interface proxy 412 and customer integration or customer delivery configuration 414; and
deploying and executing the job on the on premises or cloud server.

9. The method as claimed in claim 8, wherein the customer device 102a and developer device 102b is selected from computer systems, tablet devices, mobile telephone devices, server computer systems, handheld or laptop devices, multiprocessor systems, microprocessor-based systems, set top boxes, programmable consumer electronics, network PCs, and a distributed cloud computing environments.

10. The method as claimed in claim 8, wherein the data is selected from open application programming interfaces specification, metadata configuration, and shared flows.

11. The method as claimed in claim 8, wherein the template is an abstraction of a design pattern.

12. The method as claimed in claim 8, the APIGEE® application programming interface proxy 412 is a user interface for a developer to use backend services.

13. The method as claimed in claim 8, wherein the customer integration or customer delivery configuration 414 utilizes pull request-based code review workflows to automate deployment of code changes to a live software system.

14. The method as claimed in claim 8, wherein the repeatable build jobs are performed by the tool is selected from Jenkins, Bamboo, and Azure AD.
